(19) United States
(12) Patent Application Publication
(10) Pub. No.: US 2012/0013065 A1
(43) Pub. Date: Jan. 19, 2012

(54) DEVICE FOR SEPARATING FLAT ARTICLES, A CORRESPONDING CONTROL METHOD, AND A CORRESPONDING POSTAL MACHINE

(75) Inventors: Stephane Ambroise, Serves (FR); Stephane Samain, Chabeuil (FR); Mickael Dauvergne, Mercurol (FR)

(73) Assignee: SOLYSTIC, Gentilly Cedex (FR)

(21) Appl. No.: 13/142,346

(22) PCT Filed: Mar. 15, 2011
(86) PCT No.: PCT/FR11/50519

§ 371 Date: Jun. 27, 2011

(30) Foreign Application Priority Data
Mar. 30, 2010 (FR) 1052335

(51) Int. Cl. B65H 5/00; B65G 47/26; B65H 3/00

(52) U.S. Cl. 271/10.01; 198/459.1

(57) ABSTRACT

The invention relates to a separator device (18) comprising a passage zone (40) through which the articles pass and which extends between drive means (20, 30), retaining means (24, 34) for retaining an article relative to another article, and suitable for separating them mutually, control means suitable for activating and deactivating, independently, each first and second drive means (20, 30), and each first and second retaining means (24, 34). The drive means (20, 30) are distant from each other so as to define the passage zone (40), and the retaining means (24, 34) are suitable for exerting substantially transverse forces in opposite directions, so as to suck at least one article against corresponding drive means. The invention also relates to a method of controlling the above-mentioned separator device (18), and to a postal sorting machine including such a separator device (18).

### CROSS REFERENCE TO RELATED APPLICATION(S)

This application is a 35 U.S.C. §371 National Phase Entry Application from PCT/FR2011/050519, filed Mar. 15, 2011, designating the United States and also claims the benefit of French Application No. 1052335, filed Mar. 30, 2010, the disclosures of which are incorporated herein by reference in their entirety.

### TECHNICAL FIELD

The invention relates to the field of unstacking flat articles from a stack of flat articles, in particular small-format mailpieces, such as letters, or indeed large-format mailpieces, such as magazines, so as to put them into series and so as to transport them in series in a conveyor. The invention relates more particularly to separating such mailpieces, when they are mutually overlapping and stuck together or bunched together, forming what, in the art, may be termed “multiple takes” or “multiple feeds” of mailpieces.

### PRIOR ART

Usually, mailpieces are disposed on edge and in a stack in a magazine, facing an unstacker plate and against a jogging edge. The unstacker plate is provided with movement means such as a perforated belt co-operating with a solenoid valve, which means make it possible to move the first mailpiece of the stack in an unstacking direction that is substantially parallel to the above-mentioned plate.

Those movement means direct each mailpiece towards a conveyor, with a view to subsequent processing of said mailpiece. In a nominal situation, the various mailpieces are therefore caused to move one after another, without any mutual overlap. However, it can happen that two adjacent mailpieces overlap, so that they then form a “multiple take”. It is then necessary to separate them mutually, in order to guarantee optimum processing of each of the mailpieces in the multiple take.

It is possible firstly to handle multiple takes upstream from unstacking, by means of mechanical systems. The purpose of such systems is to separate the mailpieces, even before they are directed towards the conveyor. It is also known that multiple takes can be detected downstream from the conveyor, where they are rejected. In which case, the mailpieces cannot be processed productively.

Publication US 2009/0218751 describes a method and apparatus making it possible to separate the various mailpieces making up a multiple take. That document makes provision to use two series of drive pulleys disposed on either side of the passage zone through which the mailpieces pass. During nominal operation, the speeds of rotation of the pulleys increase going downstream while, in addition, the speeds of rotation of the pulleys belonging to one of the series are greater than the speeds of rotation of the facing pulleys belonging to the other series.

Under such conditions, in the event of a multiple take, the mailpiece that is driven by the fastest series of pulleys is caused to move at a speed that is slightly greater than the speed of the other of the mailpieces that is handled by the slower pulleys. That speed differential tends to generate a shear force that is exerted in the plane of the mailpieces, and that makes it possible to separate them mutually.

Unfortunately, that solution suffers from certain drawbacks. Its effectiveness is rather unsatisfactory because, in practice, it has been observed that that solution does not guarantee systematic separation of the mailpieces bunched together in a multiple take. In addition, it is relatively aggressive insofar as it might damage fragile mailpieces such as open ones or plastic-wrapped ones.

In addition, patent U.S. Pat. No. 3,599,967 describes a device for separating flat articles that has three drive segments, the second drive segment being disposed in part facing the first and third drive segments in such a manner as to share distinct overlap zones with them. Those drive segments are provided with belts, each of which is perforated in two distinct segments. Those belts are coupled to suction systems making it possible to press the flat articles against one or other of the belts in the perforated zones. The belts are synchronized with one another so that their perforated segments go past the overlap zone in offset manner. That separator device also has means for detecting the presence of articles facing the drive segments for the purpose of selectively controlling the suction systems. In a first situation, when a multiple take is handled by the first drive segment, one of the articles remains blocked against an abutment of the first drive segment, while the other article is pressed against the belt of the second segment so as to be conveyed towards the third segment. In a second situation, when a multiple take is handled by the first drive segment and transferred to the second drive segment, one of the articles remains blocked against an abutment of the second drive segment while the other article is pressed against the belt of the third segment so as to be conveyed towards the outlet of the device. The first and second situations depend on the way in which the articles overlap.

Patent EP 0 598 641 describes a device for dispensing flat articles, that device including a separator device having two perforated-belt drive segments facing each other so that they are close together over a first fraction and divergent over a second fraction. The belts are coupled to different suction systems so that the articles are preferably pressed against a driving belt. In addition, the belts are separated by a deflector in the divergent fraction. Thus, in the event of multiple takes of two articles, a first article remains pressed against the driving belt, while the second article is deflected by the deflector so as to be unstacked and pressed towards the second belt.

In addition, Publication JP 1 236 154 describes a flat-article separator device having two belt drive segments that are independent from each other, each drive segment being coupled to a suction system servo-controlled to means for detecting the articles.

Finally, Patent U.S. Pat. No. 6,494,446 describes a flat-article feed device comprising a supply magazine in which flat articles are moved in a stack and on edge in a first transfer direction, separator means for separating the leading flat article in the stack from the remainder of the stack and for driving it in a second transfer direction that is substantially perpendicular to the first transfer direction, unstacker means that handle a flat article that has been separated from the stack and bring it in said second transfer direction to an inlet of a conveyor. That feed device further comprises means for measuring the thickness of the article after separation, and retaining means that exert a retaining force on the flat article being unstacked, which retaining force opposes movement of the mailpiece towards the conveyor, the position of the retaining means being adjustable relative to the unstacker means and servo-controlled as a function of the thickness of the measured flat article. The unstacker means are offset and separate from the separator means in said second transfer direction, and the retaining means are provided facing the unstacker means.

Unfortunately, such devices do not make it possible to obtain accurate and reproducible unstacking while also preserving the integrity of the articles.

### SUMMARY OF THE INVENTION

An object of the invention is to remedy those drawbacks. A particular object of the invention is to propose a device making it possible to separate substantially all of the multiple takes that it might have to handle. An object of the invention is also to propose such a device that makes it possible to guarantee the integrity of the articles that are conveyed in it.

To these ends, the invention provides a separator device for separating flat articles, which device comprises an inlet, an outlet, a passage zone through which the articles pass and which extends between the inlet and the outlet, first and second drive means for driving the articles, which drive means are disposed on either side of the passage zone, and first and second retaining means for retaining at least one flat article relative to at least one other flat article, and suitable for separating them mutually, the first and second retaining means being associated respectively with the first and second drive means, said separator device being characterized in that the first and second drive means are distant from each other so as to define said passage zone through which the articles pass, in that the first and second retaining means are suitable for exerting a first force and a second force that are substantially transverse forces, in opposite directions, so as to attract at least one article against corresponding drive means, and in that it further comprises control means suitable for activating and deactivating, independently from one another, each first and second drive means, and each first and second retaining means.

The basic idea of the invention is to generate an essentially transverse force on the mailpieces in order to separate them, rather than exerting a longitudinal force as in the prior art. This is less aggressive for the mailpieces, and makes it possible to reduce the total length of the device.

A separator device of the invention may advantageously have the following features:
the first and second drive means are spaced apart by a distance lying in the range 5 millimeters (mm) to 50 mm, and preferably lying in the vicinity of 10 mm;
it further comprises means for varying the distance between the first and second drive means;
the first and second retaining means comprise suction means suitable for exerting a transverse suction force on the articles of the multiple take, and control means for controlling said suction means;
each first and second drive means is a perforated belt, and each suction means is suitable for generating suction at the surface of said perforated belt;
each suction means comprises a vacuum pump controlled by a solenoid valve, forming control means, said vacuum pump being suitable for generating suction in a suction chamber situated in the vicinity of a corresponding perforated belt;
it further comprises detection means for detecting any multiple take formed by a plurality of mutually overlapping articles;
it further comprises a pre-suction device placed on one side of the passage zone; and
it further comprises means for measuring the thickness of each article or of each multiple take of articles, which means are connected to the means for varying the distance between the first and second drive means.

The invention also provides a method of using the above separator device, in which method: i) at least one transverse force is exerted in such a manner as to separate a multiple take of a plurality of articles into a single first article and into at least one other article; and ii) the single article is removed while holding the or each other article stationary, and, after the single first article has been removed: a) if there is a single other article, it is removed from the passage zone; and b) if there are a plurality of other articles forming a multiple take of order 2, said multiple take is processed in the above steps i) and ii), until a multiple take of higher order made up of only two articles is obtained.

Finally, the invention provides a postal sorting machine including an unstacker device and a conveyor, the unstacker device including a magazine in which flat articles are disposed on edge facing an unstacker plate, said unstacker plate being arranged to isolate a first article relative to the other articles in the stack and to move it in an unstacking direction, while the conveyor is suitable for conveying the resulting unstacked articles in series and on edge, said postal sorting machine being characterized in that it further includes a separator device as defined above, interposed between the unstacker device and the conveyor.

### BRIEF DESCRIPTION OF THE DRAWINGS

The invention is described in more detail with reference to the accompanying drawings which are given merely by way of non-limiting example, and in which:

FIG. 1 is a diagrammatic plan view of a flat-article unstacker device of the invention and of a flat-article separator device of the invention;

FIG. 2 is a perspective view showing the separator device from a different angle;

FIG. 3 is a plan view showing a first mode of use of the separator device;

FIGS. 4A to 4F are plan views showing how articles advance through the separator device in the FIG. 3 mode of use;

FIG. 5 is a plan view showing a second mode of use of the separator device;

FIGS. 6A to 6E are plan views showing how articles advance through the separator device in the FIG. 5 mode of use;

FIG. 7 is a plan view showing a third mode of use of the separator device;

FIGS. 8A to 8D are plan views showing how articles advance through the separator device in the FIG. 7 mode of use;

FIG. 9 is a plan view showing a fourth mode of use of the separator device; and

FIGS. 10A to 10D are plan views showing how articles advance through the separator device in the FIG. 9 mode of use.

### DESCRIPTION OF EMBODIMENTS

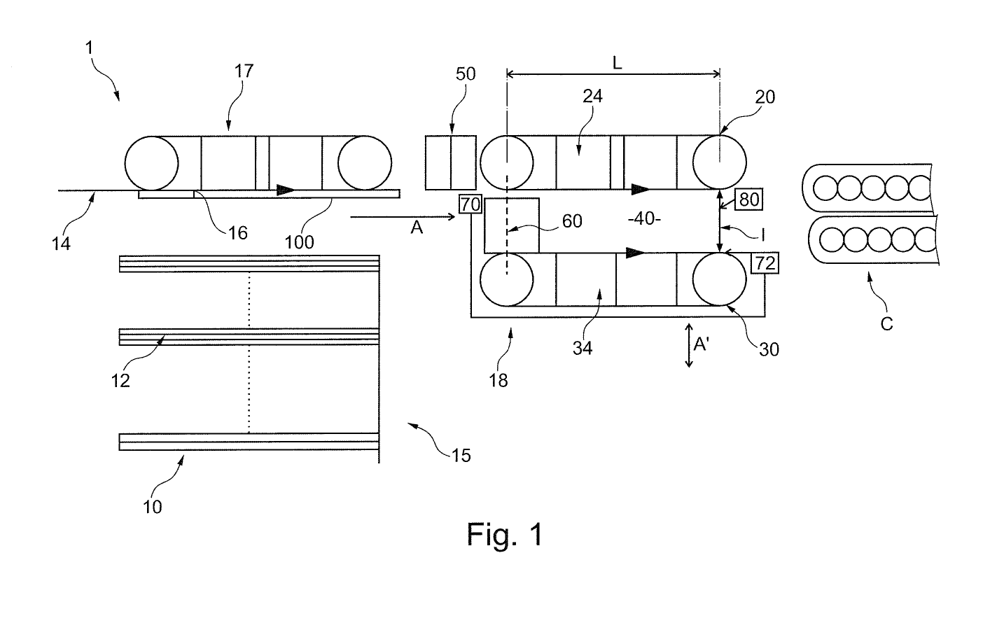

Firstly, FIG. 1 is a plan view of a device 1 making it possible to unstack flat articles that are, in this example, mailpieces. Firstly, this device includes a magazine 10 in which the mailpieces to be unstacked are disposed in a stack 12. This magazine is edged by an unstacker plate 14 against which the mailpieces bear, and by a jogging edge 15 that is substantially perpendicular to the unstacker plate.

A movement member 16 is also provided that is implemented in the form of a perforated belt co-operating with an unstacker solenoid valve 17. This member 16 is suitable for moving the first mailpiece 100 in the stack that is resting against the plate 14 in an unstacking direction indicated by the arrow A. This direction is parallel to the unstacker plate 14, namely horizontal in the figures, while also extending rightwards. The various above mechanical members are of conventional type, so that they are not described in any further detail below.

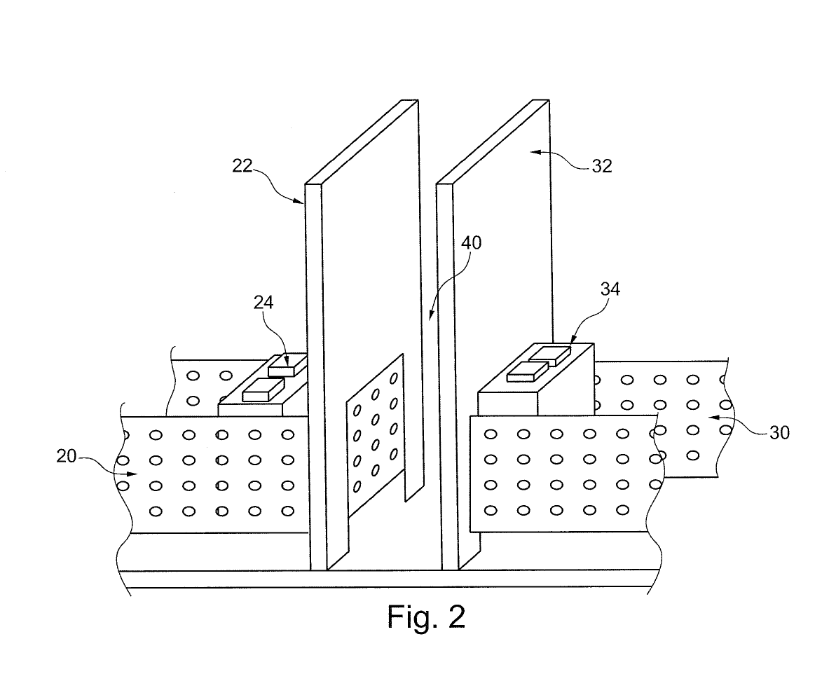

Downstream from the movement member 16, with reference to the direction A, a separator device of the invention is provided that is designated by overall reference 18. This separator device comprises two drive means that, in the example shown, are formed by two perforated belts 20 and 30. These perforated belts are of a type known per se, they form endless loops, and they are driven by usual drive means (not shown). As shown in FIG. 2, each belt 20 or 30 is incorporated in an upright 22 or 32 against which mailpieces, in particular large-size mailpieces, can bear.

The drive belts have facing faces that define a space or “channel” 40 through which the mailpieces can pass. By way of non-limiting example, the longitudinal dimension or length L of said channel 40, with reference to the direction of movement of the mailpieces, lies in the range 50 mm to 200 mm, and in particular lies in the vicinity of 100 mm. In addition, its transverse dimension, or width f, which corresponds to the spacing between the two belts, typically lies in the range 5 mm to 50 mm, and in particular lies in the vicinity of 10 mm. In other words, regardless of the mode of operation of the device, the belts are distant from each other, i.e. they are not in mutual contact.

Each belt 20 or 30 is associated with a vacuum pump of conventional type that is not shown. Each pump can generate suction inside a suction chamber (not shown) that extends behind the front face of a respective belt. This therefore makes it possible to generate a suction force, via the perforations in the belt.

In addition, solenoid valves 24 and 34 are suitable for controlling activation of a respective vacuum pump. Each solenoid valve and vacuum pump pair forms retaining means in the meaning of the invention. The belt and solenoid valve pair 20 & 24 is referred to as the “left” pair, and the pair 30 & 34 is referred to as the “right” pair, with reference to the drive direction. Various control means (not shown) are also suitable for actuating the belts and the solenoid valves independently from each other.

The device 18 may optionally also include a pre-suction element 50 that is interposed between the movement member 16 and the two belts 20 and 30. This element 50, which is of a type known per se, is placed on the same side as the belt 20, namely on the left with reference to the drive direction A.

The separator device of the invention also includes a detection system, designated by overall reference 60. With reference to FIG. 1, which is a plan view, this system is positioned at a height lower than the height of the conveyor belts 20 and 30. In other words, it enables the mailpieces 10 to be seen from below.

This system, which is placed in the vicinity of the inlet of the channel 40, is suitable for giving the arrival profile of each mailpiece that arrives in register with this system, whether on its own or in a multiple take. By way of example, at regular intervals, it can deliver information giving the position of the point of intersection at which each mailpiece intersects a line perpendicular to the conveying direction. By way of example, this detection system is as described in FR-A-2 891 168 in the name of the Applicant.

The detection system 60 is suitable for co-operating with the various controls mentioned above. To this end, respective lines (not shown) are provided that interconnect the system and the controls in pairs.

In the vicinity of this detection system, an additional sensor 70 is provided for determining the thickness of each mailpiece or group of mailpieces. This sensor 70 is connected to means 72 making it possible to move one of the belts and its suction chamber further away from or closer to the other belt and its suction chamber. This movement, that is indicated by the double-headed arrow A′, makes it possible to modify the width of the channel 40. This sensor 70 and said movement means 72 are shown diagrammatically in FIG. 1.

Finally, an “exit” sensor 80 is placed in the vicinity of the downstream end of the channel. This sensor, of any suitable conventional type, makes it possible to detect that a mailpiece has indeed left the channel. The outlet of the channel opens out into a conveyor C, of conventional type, that is shown highly diagrammatically in FIG. 1 and that makes it possible for the mailpieces to be processed subsequently, in usual manner.

Various variant modes of use of the invention are described below.

When the device is operating nominally, the control means activate the two belts 20 and 30, and the two solenoid valves 24 and 34. In other words, the mailpieces are caused to advance on both sides of the channel, and the suction forces are exerted.

If it is assumed that a single mailpiece is admitted into the channel 40, the detection system signals its arrival. The mailpiece is then conveyed through the channel, by means of one or other of the belts. The solenoid valves are also maintained in the active state.

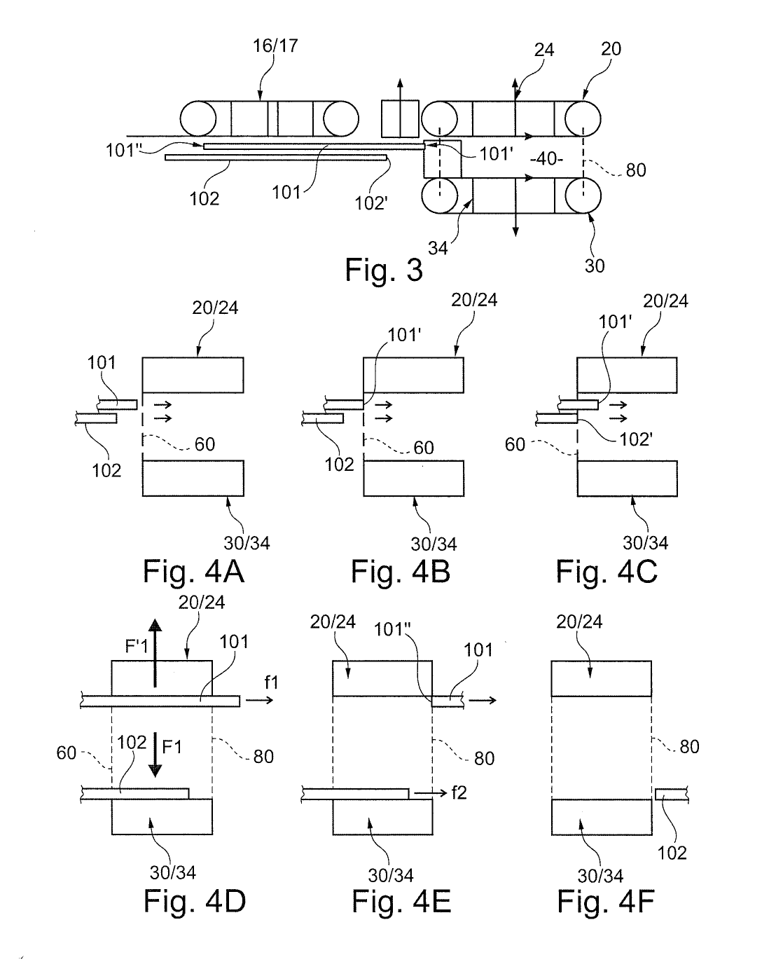

It is assumed below that a multiple take formed by two mailpieces 101 and 102, and shown in FIG. 3, is directed towards the channel 40. The leading edge 101′ of the mailpiece is ahead of the leading edge 102′ of the mailpiece 102, with reference to the direction of advance, towards the right of the figures. In addition, FIGS. 4A to 4F show the successive positions of these mailpieces, as a function of time.

At time T0 (FIG. 4A), the detection system does not signal any mailpiece. Then, at time T1 (FIG. 4B), it signals the arrival of the “leading” mailpiece 101, placed nearer the left belt and solenoid valve pair 20 & 24.

Then, at time T2 (FIG. 4C), the system 60 also detects the presence of the “trailing” mailpiece 102, placed nearer the right belt and solenoid valve pair 30 & 34. The belt 30 is then caused to stop at time T3 (FIG. 4D), while maintaining the solenoid valve 34 active and thus maintaining its associated vacuum pump active.

This therefore generates a transverse force referenced F1 in this figure, which force contributes to pressing the mailpiece 102 against the belt 30. In addition, the solenoid valve 24, which is also active, co-operates with its associated vacuum pump to generate a transverse force F′1, along the same axis and in the opposite direction relative to the above transverse force F1. This therefore makes it possible to separate the mailpiece 102 from the mailpiece 101 to which it was originally stuck.

It should be noted that the stopping inertia of the belt 30 enables the mailpiece 102 to overlap a substantial fraction of said belt, once it is blocked in position. This enables the suction force F1, generated by the solenoid valve 34, to be substantially absorbed by said mailpiece 102 so that said force does not interfere with the force F′l exerted on the other mailpiece 101.

Under these conditions, only the leading mailpiece 101 continues to advance through the channel 40, as indicated by the arrow f1 in FIG. 4D, towards the conveyor C. When the exit sensor detects passage of the trailing edge 101″, at time T4 (FIG. 4E), the belt 30 is activated once again, so that the mailpiece 102 resumes its advance through the channel as indicated by the arrow f2, so as to be handled by the conveyor C.

Finally, at time T5 (FIG. 4F) the system 60 no longer detects any mailpiece. The belts 20 and 30 remain active, as do the solenoid valves 24 and 34, so that the device is once again operating nominally.

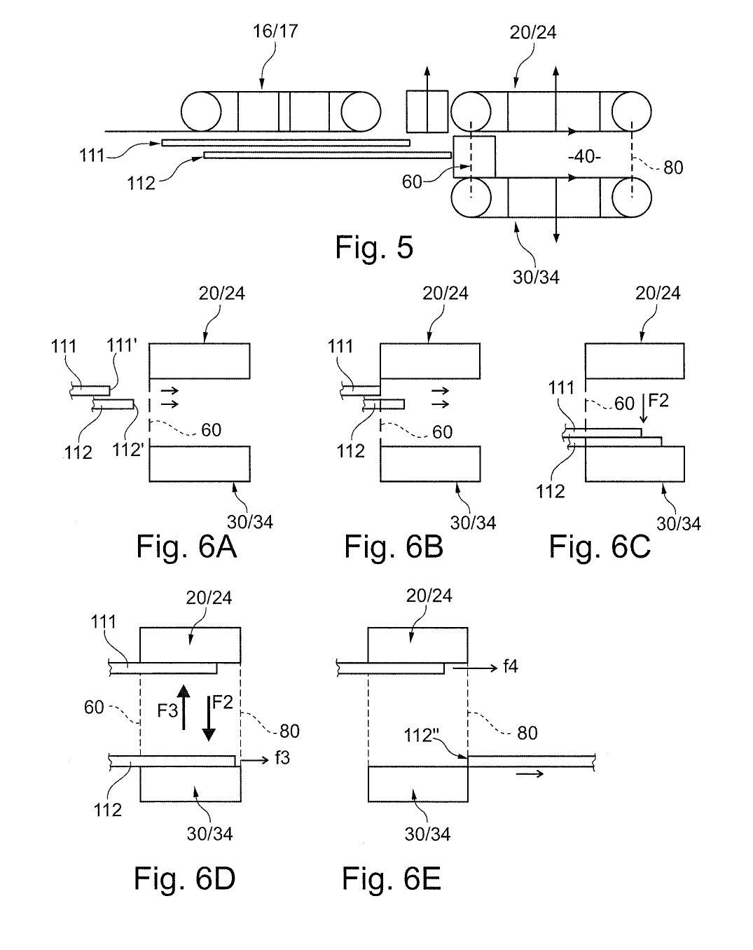

It is assumed below, as shown in FIGS. 5 and 6, that the multiple take is formed by two mailpieces 111 and 112, placed in inverted manner relative to the preceding figures. Thus, the leading edge 112′ of the mailpiece 112, facing towards the perforated belt and solenoid valve pair 30 & 34, is ahead of the leading edge 111′ of the mailpiece 111.

At time T0 (FIG. 6A), the detection system does not signal any mailpiece. Then, at time T1 (not shown in the figures), it signals only the arrival of the “leading” mailpiece 112. Then, at time T2 (FIG. 6B), the system 60 also detects the presence of the “trailing” mailpiece 111.

The belt 20 and the solenoid valve 24 are then caused to stop. The solenoid valve 34 also generates a transverse force, referenced F2 in this figure that contributes to sucking both the mailpiece 111 and the mailpiece 112 against the belt 30, as shown in FIG. 6C.

As soon as this pressing of the mailpieces against the belt is detected, the opposite solenoid valve 24 is, once again, immediately activated, while the belt 20 is maintained at rest. In this way, the mailpiece 111 is pressed against the belt 20, by application of a transverse force F3 opposite from the transverse force F2 (FIG. 6D). It should be noted that the force F2 does not interfere with the movement of the mailpiece 111, because it is substantially absorbed by the mailpiece 112, pressed against the belt 30.

Under these conditions, only the leading mailpiece 112 continues to advance through the channel, as indicated by the arrow f3 in FIG. 6D. It should be noted that it is possible to stop the belt 30, for a short time, while the mailpieces 111 and 112 are being separated.

Then, when the exit sensor detects passage of its trailing edge 112″, at time T4 (FIG. 6E), the belt 30 is, once again, caused to be activated, so that the mailpiece 111 resumes its advance through the channel as indicated by the arrow f4. It should be noted that, in certain modes of use, the suction force F2 drives the mailpiece 112 only, while the mailpiece 111 then remains in the vicinity of the belt 20. In such a situation, the device goes directly from the configuration in FIG. 6B to the configuration in 6D.

Finally, at time T5 that is not shown in the figures, the system 60 no longer detects any mailpiece, as in the situation in FIG. 4F. The belts 20 and 30 remain active, as do the solenoid valves 24 and 34, so that the device finds itself, once again, in nominal operation.

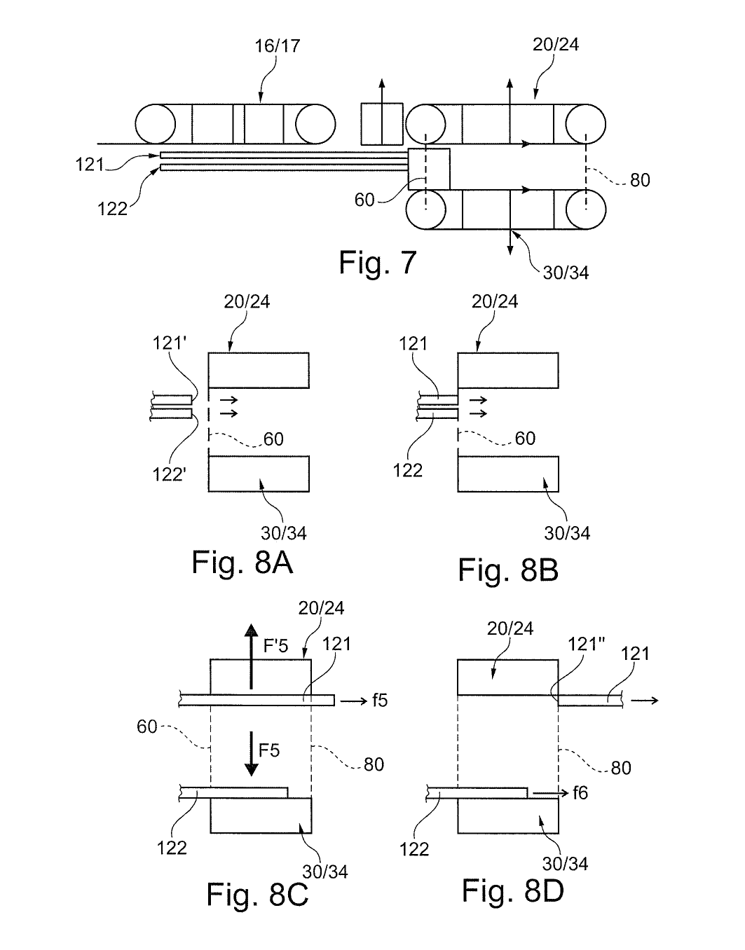

It is assumed below, as shown in FIGS. 7 and 8, that the multiple take is formed by two mailpieces 121 and 122 having their leading edges 121′ and 122′ in alignment. At time T0 (FIG. 8A), the detection system does not signal any mailpiece. Then, at time T1 (FIG. 8B), it signals simultaneous arrival of the two mailpieces, i.e. a situation analogous to the situation corresponding to time T2 in the first assumption (see FIG. 4C).

Control is then the same as the control described above with reference to FIGS. 4D et seq. Thus, the belt 30 is caused to stop at time T2 (FIG. 8C), while the solenoid valve 34 is maintained active. This generates a transverse force, referenced F5 in this figure, which force presses the mailpiece 122 against the belt 30, in a manner such as to separate the mailpiece 121 that remains attracted against the belt 20 under the effect of an opposite force F′5.

Only the mailpiece 121 then continues to advance through the channel, as indicated by the arrow f5. When the exit sensor detects passage of the trailing edge 121″, at time T3 (FIG. 8D), the belt 30 is caused to be activated once again, so that the mailpiece 122 resumes its advance through the channel, as indicated by arrow f6.

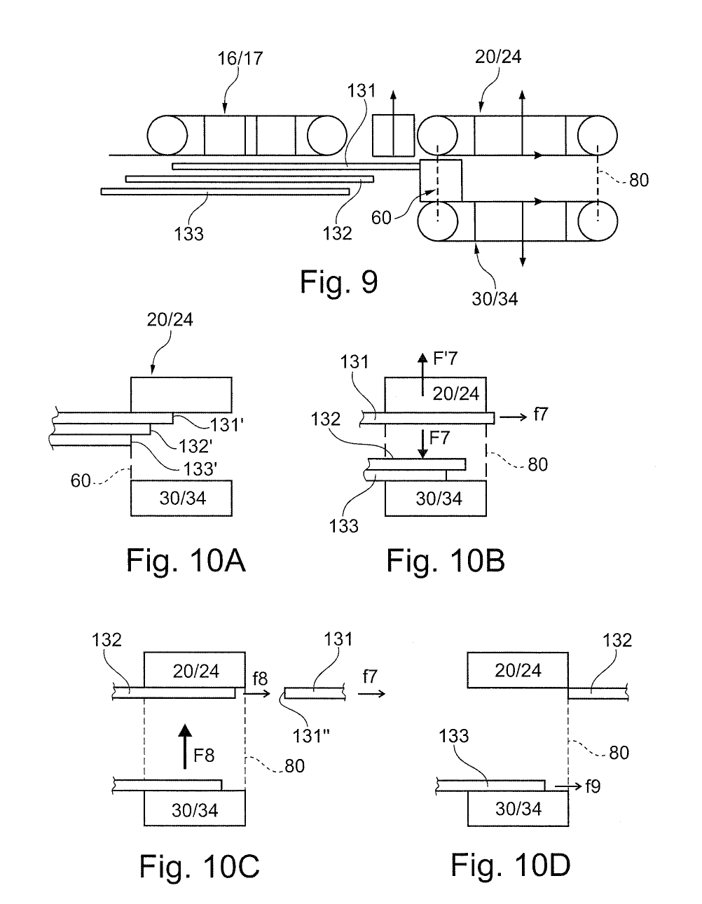

Finally, it is assumed below, with reference to FIGS. 9 and 10, that the multiple take is formed by three mailpieces 131, 132, and 133 referred to respectively as “leading”, “intermediate”, and “trailing” mailpieces, the leading edges 131′, 132′, and 133′ of which are offset relative to one another. At time T0, the detection system signals no mailpiece. Then, at time T1, it signals the arrival of the “leading” mailpiece 131, placed nearest to the perforated belt and solenoid valve pair 20 & 24. These two first steps, analogous to the steps described above, are not shown in the figures.

Then, at time T2 (FIG. 10A), the system 60 detects the presence of two additional mailpieces 132 and 133. For simplification purposes, it is assumed that these two mailpieces are detected at the same time. In this regard, the mode of use would be identical if the two detections were successive.

The belt 30 is then caused to stop at time T3 (FIG. 10B), while the solenoid valve 34 is maintained active. The resulting transverse force F7 that is generated presses the two mailpieces 132 and 133 against the belt 30, so as to separate them from the mailpiece 131, to which they were originally stuck. This mailpiece 131 remains pressed against the belt 20, under the effect of a force F′7 generated by the solenoid valve 24.

Only the leading mailpiece 131 thus continues to advance through the channel, as indicated by the arrow f7. Once the exit sensor has detected passage of the training edge 131″, at time T4 (FIG. 10C), the right solenoid valve 34 is deactivated, so that the intermediate mailpiece 132 is pressed, as indicated by the arrow F8, against the left solenoid valve 24, which remains activated. By being stopped, the solenoid valve 34 no longer interferes with free transverse movement of the mailpiece 132 that had its leading edge (projecting relative to the trailing mailpiece) in contact with the right belt 30. It should also be noted that the trailing mailpiece remains pressed against said belt 30.

As soon as the intermediate mailpiece finds itself in contact with the left belt 20, the right solenoid valve is activated once again, while also keeping the belt 30 stationary, so as to maintain the position of the trailing mailpiece 133. The intermediate mailpiece 132 is then removed from the channel, as indicated by the arrow f8 in FIG. 10C. When the system 60 detects passage of its trailing edge 132″ (FIG. 10D), the trailing mailpiece 133 is, once again, conveyed by the belt 30, as indicated by the arrow f9, so as to exit from the channel.

Finally, as in the above-mentioned modes of use, the system 60 no longer detects any mailpiece. The belts 20 and 30 remain active, as do the solenoid valves 24 and 34, so that the device finds itself, once again, in nominal operation.

Processing multiple takes formed by a number of mailpieces greater than three may be implemented iteratively, using the above steps. In general, for a multiple take of n mailpieces, a first mailpiece is separated from the (n-1) others and is removed. Then, the remaining mailpieces are managed as a secondary multiple take “of order 2”. A single mailpiece is then separated from the (n-2) others which then form a multiple take of order 3 that is processed as above. At the end of these steps, a multiple take of order (n-1) formed of two mailpieces only is obtained, and the two mailpieces are separated as explained above.

The invention makes it possible to achieve the above-mentioned objects. The use of a force that is essentially transverse for the purpose of separating the mailpieces belonging to a multiple take offers specific advantages.

Thus, in the prior art represented by U.S.2009/0218751, the mailpieces are separated by friction, namely by means of a force exerted substantially longitudinally. That tends to damage the mailpieces, in particular the ones that are fragile. In addition, the separator device described in that document necessarily has long length because it does not stop the mailpiece separated from the multiple take.

In accordance with the invention, the force exerted transversely guarantees a clear-cut separation, thereby making it possible to guarantee the integrity of the mailpieces. In addition, since use is accompanied by a clear-cut stop in the advance of the mailpieces, the device of the invention can have longitudinal dimensions that are reasonable.

1-11. (canceled)

12. A separator device for separating flat articles, which device comprises an inlet, an outlet, a passage zone through which the articles pass and which extends between the inlet and the outlet, first and second drive means for driving the articles, and first and second retaining means for retaining at least one article relative to at least one other article, and suitable for separating them mutually, the first and second retaining means being associated respectively with the first and second drive means,
wherein the first and second drive means are spaced from each other so as to define said passage zone through which the articles pass, in that the first and second retaining means are suitable for exerting a first force and a second force that are substantially transverse forces, in opposite directions, so as to attract at least one article against corresponding drive means, further comprising control means suitable for activating and deactivating, independently from one another, each first and second drive means, and each first and second retaining means.

13. A separator device according to claim 12, wherein the first and second drive means are spaced apart by a distance of 5 mm to 50 mm.

14. A separator device according to claim 12, further comprising means for varying the distance between the first and second drive means.

15. A separator device according to claim 12, wherein the first and second retaining means comprise suction means suitable for exerting a transverse suction force on the articles of the multiple take, and control means for controlling said suction means.

16. A separator device according to claim 15, wherein each first and second drive means is a perforated belt, and each suction means is suitable for generating suction at the surface of said perforated belt.

17. A separator device according to claim 16, wherein each suction means comprises a vacuum pump controlled by a solenoid valve, forming control means, said vacuum pump being suitable for generating suction in a suction chamber situated in the vicinity of a corresponding perforated belt.

18. A separator device according to claim 12, further comprising detection means for detecting any multiple take formed by a plurality of mutually overlapping articles.

19. A separator device according to claim 12, further comprising a pre-suction device placed on one side of the passage zone.

20. A separator device according to claim 14, further comprising means for measuring the thickness of each article or of each multiple take of articles, which means are connected to the means for varying the distance between the first and second drive means.

21. A separator device according to claim 12, wherein the control means is configured to operate such that:
i) at least one transverse force is exerted in such a manner as to separate a multiple take of a plurality of articles into a single first article and into at least one other article; and
ii) the single article is removed from the passage zone while holding the or each other article stationary, and, after the single first article has been removed:
a) if there is a single other article, it is removed from the passage zone; and
b) if there are a plurality of other articles forming a multiple take of order 2, said multiple take is processed in the above steps i) and ii), until a multiple take of higher order made up of two articles only is obtained.

22. A postal sorting machine including an unstacker device and a conveyor, the unstacker device including a magazine in which flat articles are disposed on edge facing an unstacker plate, said unstacker plate being arranged to isolate a first article relative to the other articles in the stack and to move it in an unstacking direction, while the conveyor is suitable for conveying the resulting unstacked articles in series and on edge, said postal sorting machine further including a separator device according claim 12, interposed between the unstacker device and the conveyor.

23. A separation device according to claim 12, wherein the first and second drive means are spaced apart by a distance of about 10 mm.
